(19) United States
(12) Patent Application Publication
(10) Pub. No.: US 2005/0023796 A1
(43) Pub. Date: Feb. 3, 2005

(54) Waste receptacle transport device

(76) Inventor: Todd A. Rasmussen, North Branch, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/806,058

(22) Filed: Mar. 22, 2004

Related U.S. Application Data
(60) Provisional application No. 60/456,314, filed on Mar. 20, 2003.

(51) Int. Cl. B60D 1/24; B60D 1/48; B60D 1/58; A47K 11/04

(52) U.S. Cl. 280/400

(57) ABSTRACT

A waste receptacle transport device consists of a vehicle attachment device being connected to a waste receptacle attachment device. The vehicle attachment device can be angularly adjustable to accommodate adhesion to a variety of body surfaces of tow vehicles. In addition, the waste receptacle attachment device is attachable to waste receptacles having a variety of shapes and sizes. When the waste receptacle transport device is attached between the respective tow vehicle and waste receptacle, the waste receptacle transport device is able to tow the waste receptacle using wheels on the waste receptacle from a first location to a second location. The waste receptacle may be towed without regard to inclement weather and adverse terrain. Alternatively, the waste receptacle transport device can be integral to the waste receptacle to form a towable waste receptacle

### PRIORITY CLAIM

The present application claims priority to U.S. Provisional Application No. 60/456,314, entitled “E-Z Hauler”, filed Mar. 20, 2003, and herein incorporated by reference in its entirety.

### FIELD OF THE INVENTION

The present invention relates generally to receptacle transport devices and, more particularly, to an apparatus attachable to and compatible with a variety of automotive vehicle designs for transporting domestic waste receptacles.

### BACKGROUND OF THE INVENTION

Many waste disposal companies have automated their collection of waste at a given residence by mounting a mechanical device on the side of the collection truck, which engages the respective waste receptacle and hoists the container thereby dumping the contents into the bin of the truck. In order to facilitate this process, waste disposal companies provide their customers with special waste receptacles for weekly pickup. These receptacles range in a variety of shapes and sizes, but typically are oversized so that one waste receptacle can accommodate the needed volume and weight (typically up to about 75 pounds) of weekly generated waste for the respective household.

Some of these waste receptacles are equipped with a horizontal lift bar that is molded into the container allowing the mechanical device to engage the waste receptacle and dump its contents. Other waste receptacles do not require this horizontal bar, as the mechanical device is adapted to grasp the outside of the waste receptacle. Most waste receptacles include integral wheels allowing the user to maneuver the receptacle from a loading location proximate the residence to a collection position proximate a road. The waste receptacles also contain a hinged lid, which can incorporate one or more handles for tilting the container onto its wheels.

In many rural areas, the collection point of the waste receptacle may be a considerable distance from the residence making it impractical and difficult to manually wheel the waste receptacle to the collection point. The difficulties of manually transporting these oversized receptacles is further magnified during inclement weather such as rain, snow, high and low temperatures or when difficult terrain must be traversed between the residence and the collection point such as gravel roads, mud and elevational changes. Typically, these oversized containers do not fit into most passenger vehicles. Even if a homeowner has a vehicle equipped to deal with these oversized receptacles, their increased weight presents a great difficulty in lifting these receptacles into the back of a pick-up truck or onto a pulled trailer, not to mention the potential safety issues associated with lifting these heavy loads.

A number of devices have been employed to overcome these problems. For instance, a trailer may be used to transport the receptacles behind a passenger vehicle or pick-up truck. Other devices also mount to the hitch of the vehicle or are supported by brackets that permanently attach to the bumper of the vehicle. Such devices lift the waste receptacle off of the ground during transportation by using a telescopic mount or lever arms that engage the horizontal lift bar. However, all of these devices require the use of a hitch and/or bracket, are not easily stored, and use complex and/or heavy mechanical parts. Additionally, the use of horizontal lift bar devices is limited only to those waste receptacles that actually include a horizontal lift bar. Moreover, these devices require considerable amounts of time and effort in connecting the devices to the vehicle, especially if the device needs to be removed from the vehicle between the time the waste receptacle is transported to the collection point and when it is retrieved from the collection point.

It is therefore desirable to provide an efficient, cost-effective device that engages with the variety of existing waste receptacles and is compatible with virtually all types of vehicles. Such a device would not have the limitations of needing a hitch or other permanent attachment to the vehicle, needing a horizontal lift bar on the waste receptacle, requiring the user to lift the container, or present storage problems.

### SUMMARY OF THE INVENTION

A receptacle transport device described herein provides a means of transporting waste receptacles equipped with integral wheels from one location to a desired location with the use of a vehicle. For example, the waste receptacles may be transported from the point of waste receptacle storage (typically a residence) to the point of a disposal company's waste receptacle collection (typically the end of the driveway along a road or highway). The receptacle transport device eliminates the need for manual lifting of the waste receptacle (either full or empty), a hitch on the vehicle being used to transport the waste receptacle, a horizontal bar on the waste receptacle being transported, and excessive amounts of time and effort to attach/detach the receptacle transport device to the vehicle being used for transportation of the waste receptacle. The waste receptacle transport device can accommodate various shapes and sizes of existing waste receptacles, and it is compatible with any type of vehicle whether or not the vehicle is dirty, wet, cold, hot, or clean. Additionally, the waste receptacle transport device can be used during any inclement weather, and it can be used to transport the waste receptacle transport device across difficult terrain including sand, gravel, mud, snow, slush, steep inclines and declines, and ruts in a driveway.

In view of the foregoing, certain embodiments of the invention provide apparatus and methods that enable a waste receptacle to be transported from one location to a different location.

Other aspects of embodiments of the invention provide apparatus and methods that allow transportation of waste receptacles that are of different sizes and shapes.

Other aspects of embodiments of the invention provide apparatus and methods that allow transportation of waste receptacles that are oversized.

Still further aspects of embodiments of the invention provide apparatus and methods that allow transportation of waste receptacles with the use of various designs and models of vehicles.

Other aspects of embodiments of the invention provide apparatus and methods that allow transportation of waste by vehicles that are dirty, cold, hot, wet, or clean.

Other aspects of embodiments of the invention provide apparatus and methods that allow transportation of waste receptacles through inclement weather and/or adverse terrain.

Other aspects of embodiments of the invention provide apparatus and methods that allow transportation of waste receptacles by towing.

Other aspects of embodiments of the invention provide apparatus and methods that are flexible so that transportation of waste receptacles may be accomplished by towing waste receptacles over and/or through mud, sand, gravel, slush, ruts, or pavement.

Still other aspects of embodiments of the invention provide apparatus and methods that allow transportation of waste receptacles in a time efficient manner.

Other aspects of embodiments of the invention provide apparatus and methods that allow transportation of waste receptacles without having to manually lift the waste receptacle.

Other aspects of embodiments of the invention provide apparatus and methods that allow transportation of waste receptacles in a cost-effective manner.

Other aspects of embodiments of the invention provide apparatus and methods that allow transportation of waste receptacles without having to exert much physical effort.

Other aspects of embodiments of the invention provide apparatus and methods that allow transportation of waste receptacles in rural areas where driveways are considerably long.

Other aspects of embodiments of the invention provide apparatus and methods that allow transportation of waste receptacles without damaging the vehicle used for transportation.

Still other aspects of embodiments of the invention provide apparatus and methods that allow transportation of waste receptacles without the use of hitch on a vehicle.

Further aspects of embodiments of the invention provide apparatus and methods that allow transportation of waste receptacles by people of various sizes, strengths, ages, and/or age.

### BRIEF DESCRIPTION OF THE DRAWINGS

Further features of the present invention, its nature and various advantages will be more apparent from the accompanying drawings and the following detailed description of certain embodiments, in which:

FIG. 1 is a perspective view of a waste receptacle;

FIG. 2 is a perspective view of an embodiment of a waste receptacle transport device of the present invention;

FIG. 3 is a perspective view of an embodiment of a waste receptacle transport device of the present invention;

FIG. 4 is a top plan view of an embodiment of the waste receptacle transport device of the present invention;

FIG. 5 is a side view of a vehicle attachment device of the present invention;

FIG. 6 is a perspective view of an embodiment of the waste receptacle transport device of the present invention attached to a vehicle;

FIG. 7 is a perspective view of an embodiment of the waste receptacle transport device of the present invention towing a waste receptacle;

FIG. 8 is a perspective view of an embodiment of the waste receptacle transport device of the present invention towing a waste receptacle;

FIG. 9 is a perspective view of an embodiment of the waste receptacle transport device of the present invention towing a waste receptacle;

FIG. 10 is a side view of an embodiment of the waste receptacle transport device of the present invention;

FIG. 11 is a perspective view of an embodiment of a towable waste receptacle of the present invention;

FIG. 12 is a side view of a securement strap used in conjunction with the waste receptacle transport device of the present invention;

FIG. 13 is a side view of a securement strap used in conjunction with the waste receptacle transport device of the present invention;

FIG. 14. is a side view of an embodiment of the waste receptacle transport device of the present invention; and

FIG. 15 is a side view of the waste receptacle transport device of FIG. 14 during towing.

### DETAILED DESCRIPTION OF THE PREFERRED EMBODIMENTS

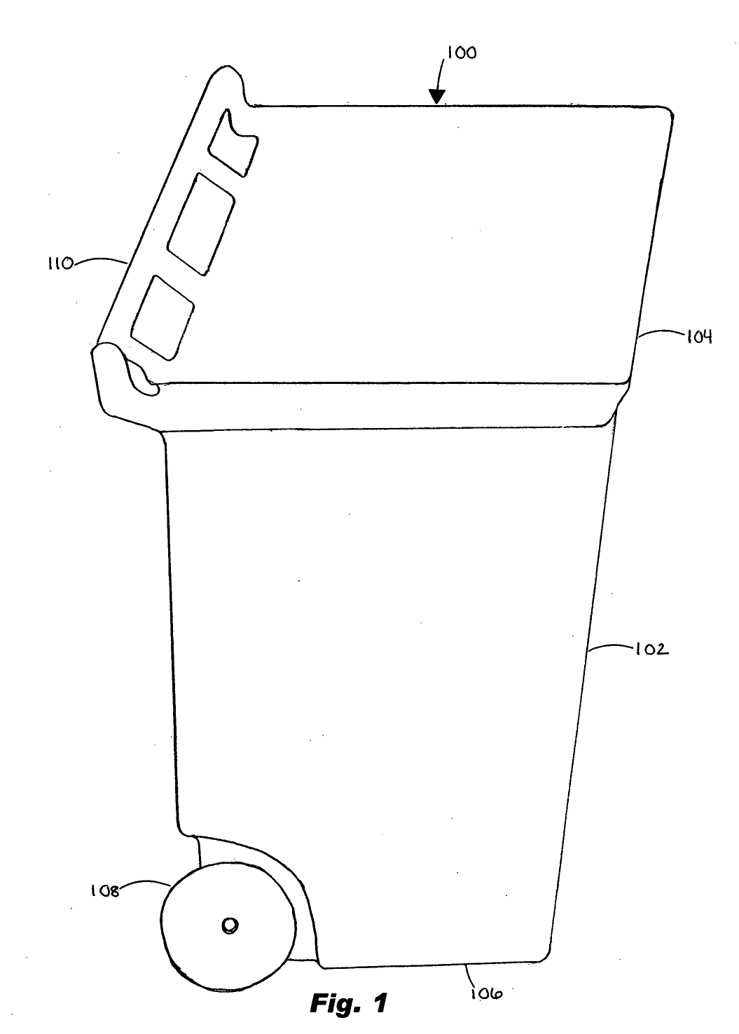

Referring now to the drawings, FIG. 1 shows a waste receptacle 100 typical of the type provided by waste disposal companies. The waste receptacle 100 has a molded body 102 with an integral hinged lid 104, bottom 106, and a plurality of wheels 108. The hinged lid 104 incorporates a handle portion 110 allowing the user to tilt the waste receptacle 100 off of its bottom 106 and onto its wheels 108 and thereby maneuver the waste receptacle 100 to a desired location.

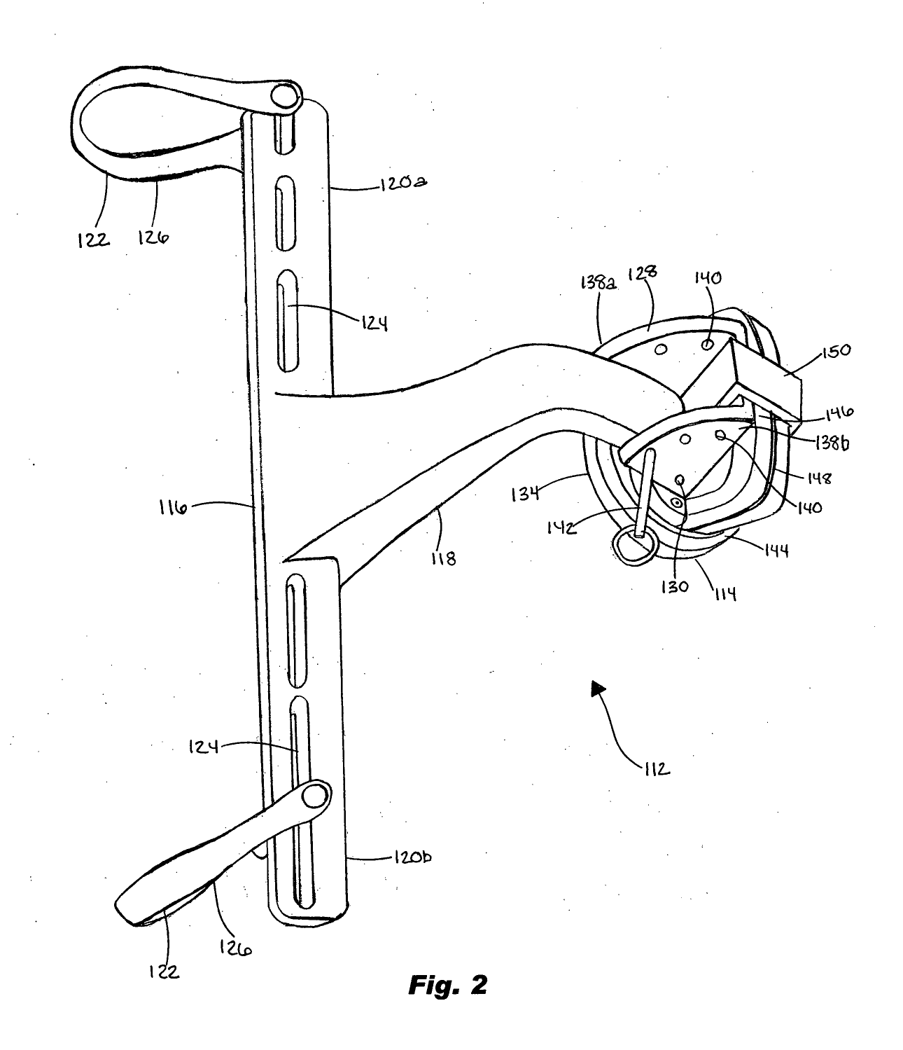

In an embodiment shown in FIGS. 2-4, a waste receptacle transport device 112 comprises a vehicle attachment device 114 and a waste receptacle attachment device 116. Vehicle attachment device 114 and waste receptacle attachment device 116 are operably connected at opposing ends of an offset linkage bar 118.

Waste receptacle attachment device 116 comprises a pair of arms 120a, 120b and at least one handle attachment device 122. Arms 120a, 120b are arranged generally perpendicular to offset linkage bar 118 to form an overall T-shape. Preferably, offset linkage bar 118 and arms 120a, 120b are an integral plastic piece, such as high-density polyethylene or other suitable polymers, formed by an appropriate molding process such as injection molding. Alternatively, the offset linkage bar 118 and arms 120a, 120b can comprise separate, connectable components fabricated from aluminum or other suitable materials. In an alternative embodiment, arms 120a, 120b can be angled with respect to offset linkage bar 118 to form an overall Y-shape.

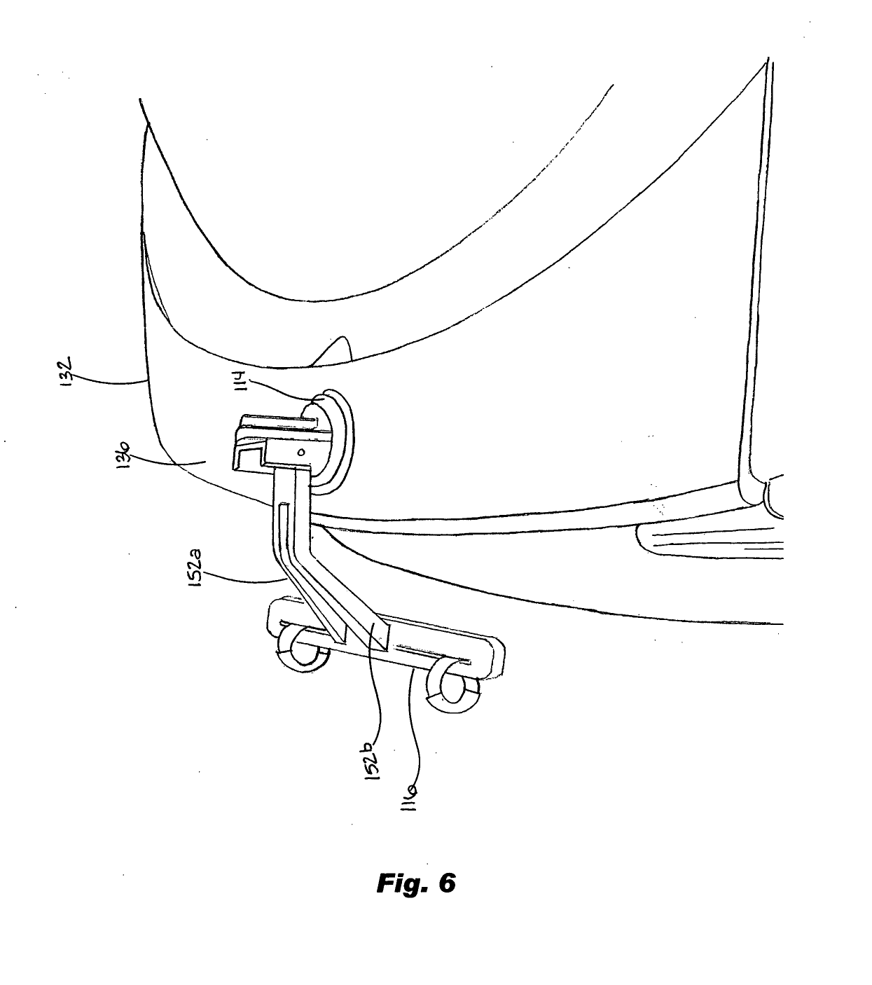

Preferably, arms 120a, 120b each contain at least one aperture 124. Alternatively, arms 120a, 120b can share a common aperture 124. Aperture 124 allows handle attachment device 122 to wrap about the handle portion 110 of waste receptacle 100. The handle attachment device 122 can comprise flexible elastomeric straps 126, as shown in FIGS. 2-4, cloth-like material including hook and loop fasteners as shown in FIGS. 6-8, a bungee cord or a metal chain. Handle attachment device 122 can provide flexibility to the waste receptacle transport device 112 during towing of the waste receptacle 100 to the desired location. Alternatively, the handle attachment device 122 can consist of a clip that operably engages with the handle portion 110. In an alternative embodiment, the handle attachment device 122 is an integral part of arms 120a, 120b such that aperture 124 is not required.

Vehicle attachment device 114 is attached to the offset linkage bar 118 at a bracket 128. In one embodiment, the vehicle attachment device 114 and bracket 128 are fastened together with a suitable fastener such as a screw or a nut and bolt. Alternatively, the bracket 128 and vehicle attachment device 114 can comprise a single, integral part. Offset linkage bar 118 is connected to bracket 128 by way of a hinged fastener 130. The hinged fastener 130 allows the offset linkage bar 118 and vehicle attachment device 114 to be arranged with respect to each other in various orientations. The orientation can be based on characteristics such as a tow vehicle orientation and type as well as the shape and size of waste receptacle 100.

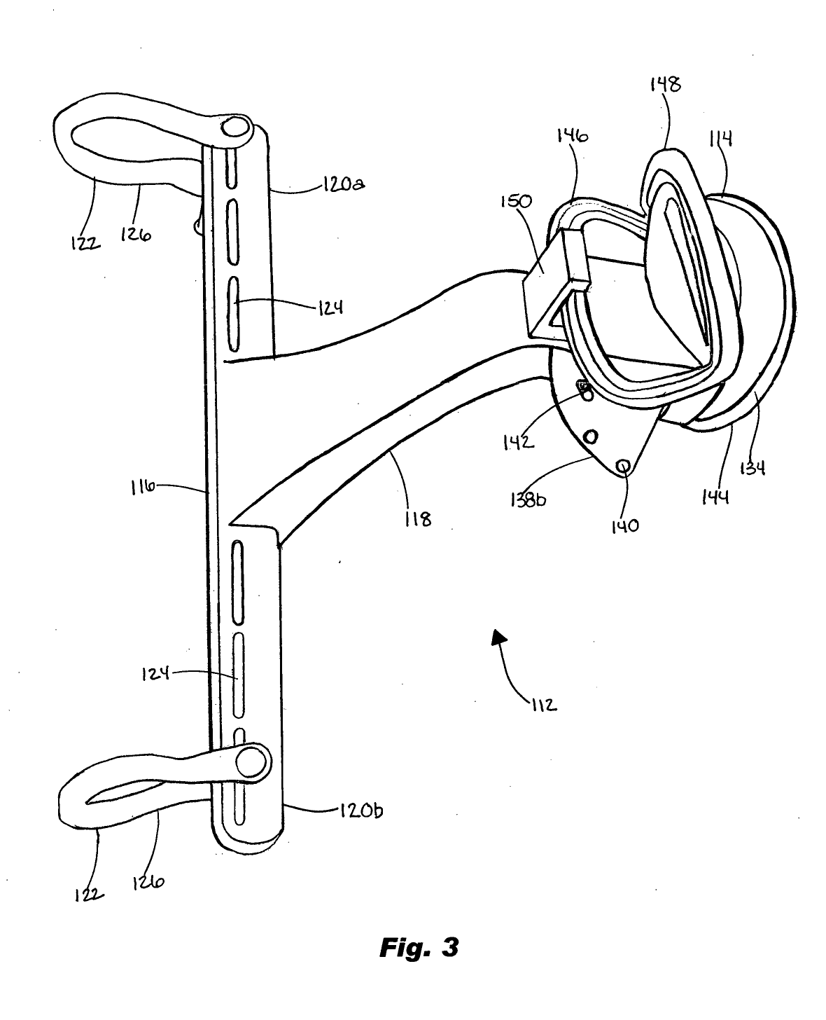

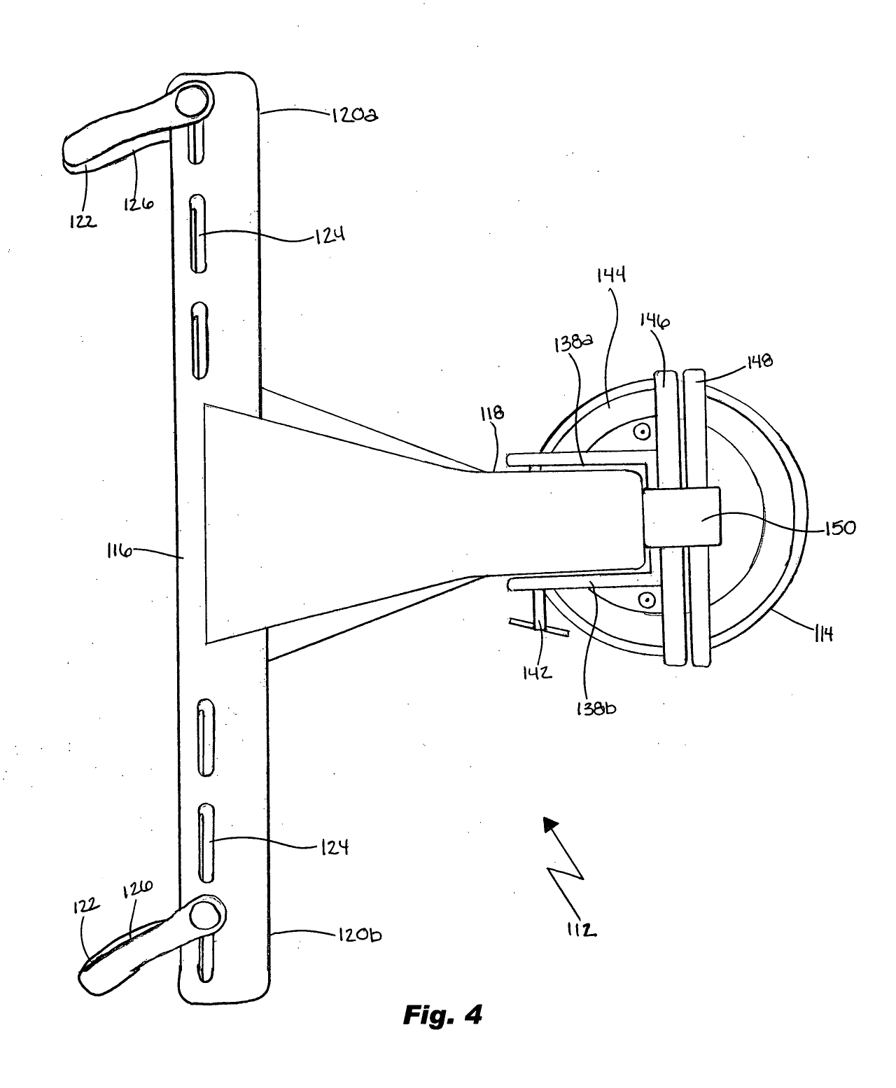

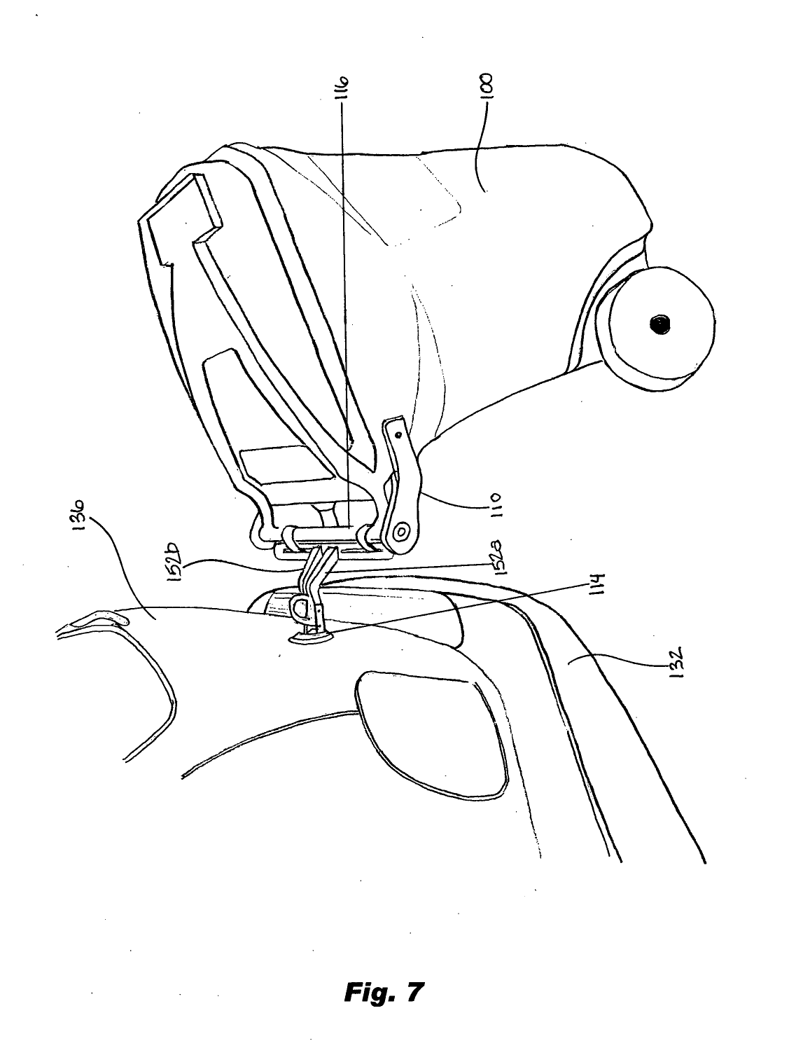

For example, when waste receptacle transport device 112 is attached to a vehicle 132 in the form of a traditional sedan as shown in FIG. 6, an interface surface 134 of vehicle attachment device 114 will engage with a body surface 136 that is generally horizontal, for example the trunk or spoiler of vehicle 132. Therefore, the interface surface 134 will lie in a generally horizontal plane, as illustrated in FIGS. 2 and 4, and thereby generally be in a parallel plane to the plane of arms 120a, 120b. However, if the vehicle 132 is instead in the form of a SUV (Sport Utility Vehicle), truck, or van, interface surface 134 will most likely engage with the body surface 136 in a generally vertical plane, such as a hatch-back door, back-door, or tailgate as depicted in FIG. 7. Therefore, interface surface 134 will lie in a vertical plane as illustrated in FIG. 3, and thereby generally be in a perpendicular arrangement with respect to the plane defined by arms 120a, 120b. Still further, if the vehicle has a sloped or arcuate body surface 136, such as those found on vehicles traditionally manufactured by Volkswagen AG of Wolfsburg, Germany, interface surface 134 will be in a position that is neither perpendicular or parallel to the plane of arms 120a, 120b. While it is envisioned that the waste receptacle transport device 112 will be used most frequently with an automobile, other motorized vehicles could be employed as well including lawn tractors, four-wheelers, golf carts or even snowmobiles.

As illustrated in FIGS. 2, 4 and 5, the bracket 128 preferably contains two side plates 138a, 138b. Side plates 138a, 138b contain a plurality of pin receiving apertures 140 to receive pin 142. Similarly, offset linkage bar 118 contains a pin-receiving aperture that is positioned between side plates 138a, 138b. Therefore, when the offset linkage bar 118 is positioned with respect to the vehicle attachment device 114, pin 142 is inserted into the respective pin-receiving aperture 140 of side-plate 138a. Pin 142 is advanced into the pin-receiving aperture of offset linkage bar 118 and through pin-receiving aperture 140 of side-plate 138b thereby locking the offset linkage bar 118 into the desired orientation with respect to vehicle attachment device 114. Alternatively, the pin 142 can be replaced with a variety of locking means, such as a spring lever integral with the offset linkage bar 118. The spring lever may be such that the ends of the lever protrude out through apertures 140 to hold the offset linkage bar 118 in the preferred orientation with respect to the vehicle attachment device 114. In such an example, the user would push the protruding ends toward each other (into the offset linkage bar 118 body) in order to change the orientation of the offset linkage bar 118 with respect to the vehicle attachment device 114. In still another alternative embodiment, the offset linkage bar 118 may be positioned between two pins rather than the pin penetrating through the body of the offset linkage bar 118.

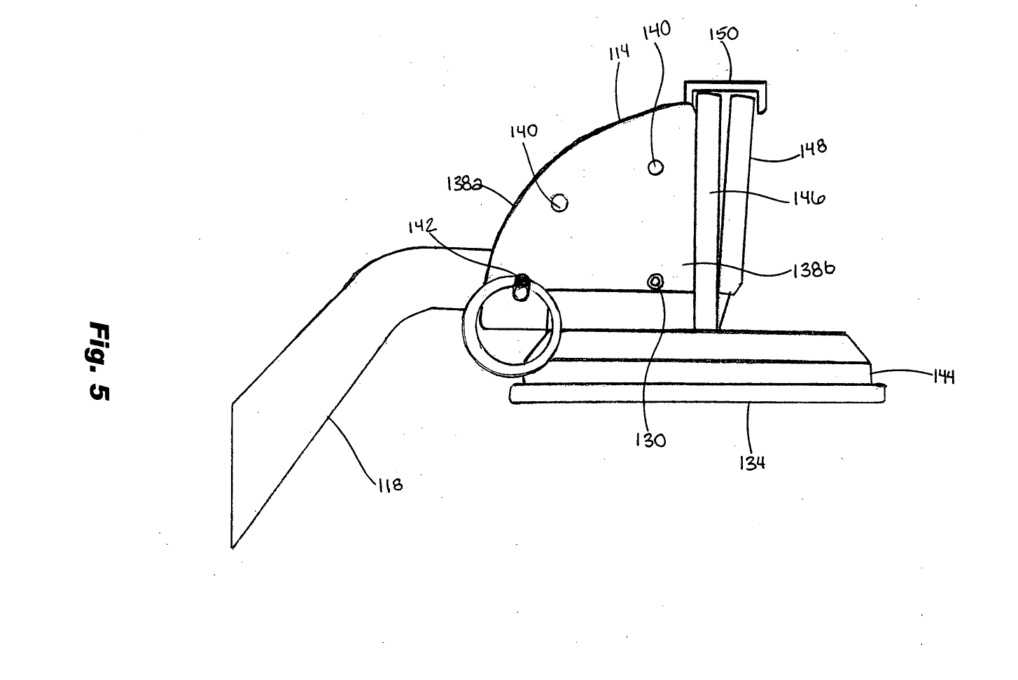

Preferably, vehicle attachment device 114 consists of a suction cup 144, as illustrated in FIGS. 1-9. Alternatively, vehicle attachment device 114 can comprise a magnet. Interface surface 134 of suction cup 144 forms an airtight seal with respect to the body surface 136 of the vehicle 132, and may be used without damaging the paint of the vehicle 132. Additionally, suction cup 144 can be used when the vehicle 132 is dirty, wet, cold, hot, or clean. Suction cup 144 preferably contains a fixed handle 146 and a moveable handle 148, which has an open position, illustrated in FIG. 3, and a closed position as illustrated FIGS. 2 and 5. Suction cup 144 transitions from the open position (unengaged with respect to the body surface 136) to the closed position (engaged with respect to the body surface 136) by squeezing the handles such that the moveable handle 148 is positioned adjacent to fixed handle 146. As suction cup 144 is moved from the unengaged position to the engaged position, the suction cup 144 sealing engages the respective body surface 136 of the vehicle 132. The body surface 136 of the vehicle 132 preferably contains at least a four-inch generally flat or smooth engagement surface.

When moveable handle 148 is in the closed (or engaged) position, moveable handle 148 may be held in the closed position by way of a lock 150. Lock 150 is preferably attached to bracket 128 and slides from a locked position to an unlocked position, and vice versa. Lock 150 may alternatively snap from a locked position to an unlocked position, and vice versa. In the locked position, lock 150 prevents moveable handle 148 from moving from the engaged position to the unengaged position. When lock 150 is in the unlocked position, moveable handle 148 is free to move between the engaged and unengaged positions.

In an alternative embodiment, illustrated in FIGS. 6 and 7, the vehicle attachment device 114 and the waste receptacle attachment device 116 are connected by a plurality of offset linkage bars 152a, 152b. Further, side-plates 138a, 138b of bracket 128 contain dual pin receiving apertures 140 to receive pin 142. Therefore, offset linkage bars 152a, 152b and vehicle attachment device 114 can be arranged in two different orientations. For example, one orientation may be such that the interface surface 134 is in a vertical position and thereby generally in a perpendicular plane with respect to the plane of arms 120a, 120b. Another orientation is such that the interface surface 134 is in a horizontal position and thereby generally in a parallel plane with respect to the plane of arms 120a, 120b.

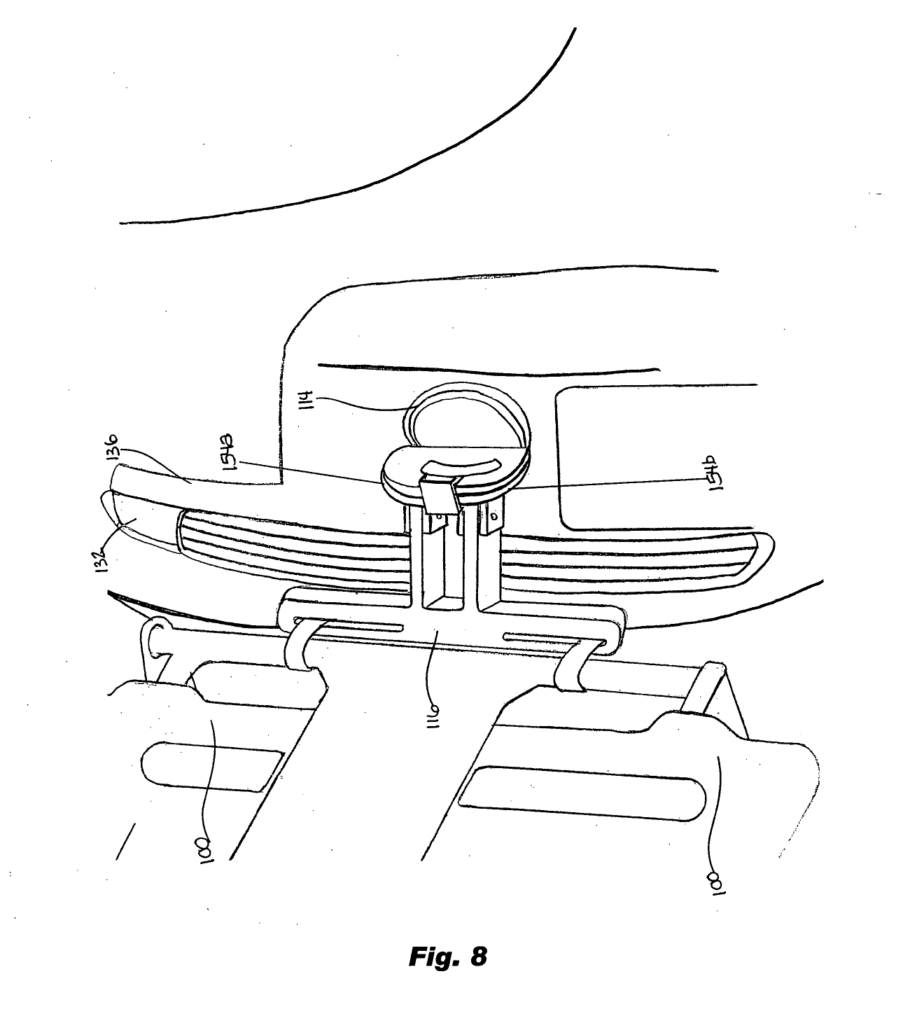

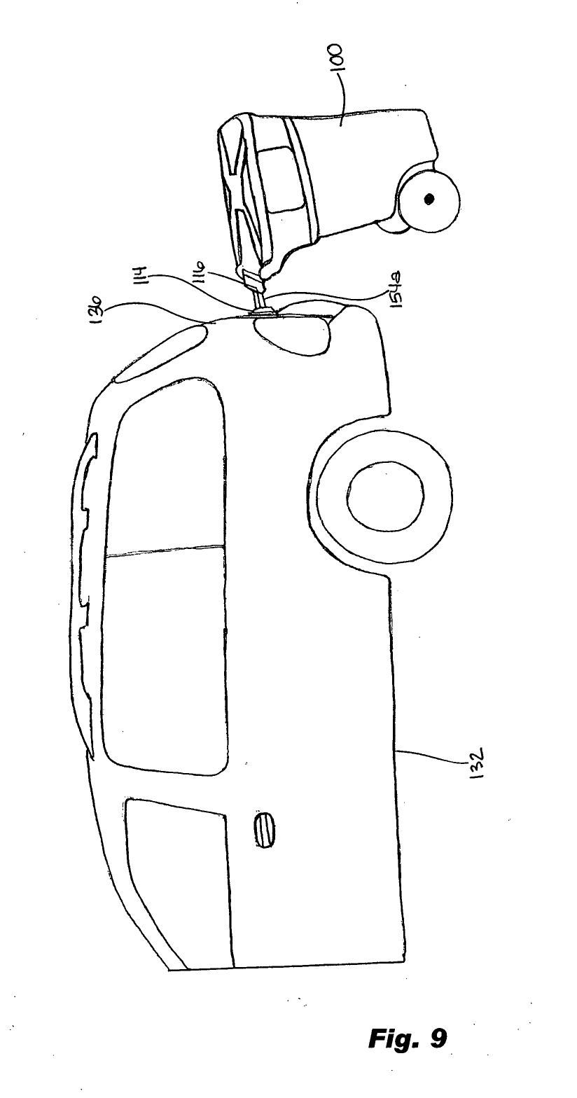

In another alternative embodiment, the vehicle attachment device 114 and the waste receptacle attachment device 116 can be connected by at least one straight linkage bar. As illustrated in FIGS. 8 and 9, the straight linkage bar may consist of a pair of straight linkage bars 154a, 154b. Further, bracket 128 does not lock straight linkage bars 154a, 154b into a desired angular position with respect to vehicle attachment device 114. Instead, straight linkage bars 154a, 154b are free to pivot on the axis of hinged fastener 130 in various orientations during the transportation of waste receptacle 100. Alternatively, the vehicle attachment device 114 and the waste receptacle attachment device 116 can be operably connected by offset linkage bar 118 or a plurality of offset linkage bars that are similarly free to pivot on the axis of hinged fastener 130 in various orientations during the transportation of waste receptacle 100.

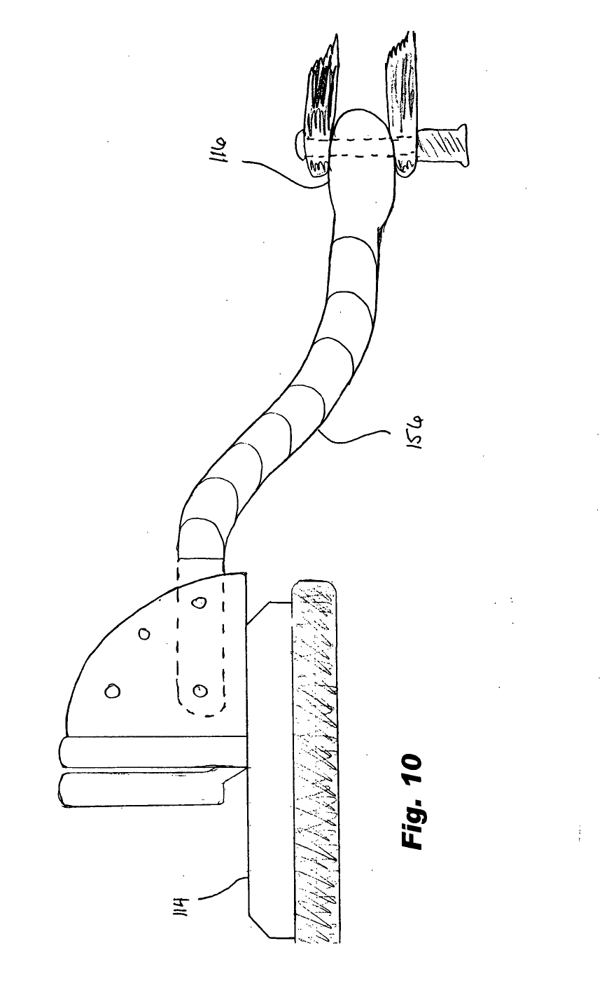

In another alternative embodiment illustrated in FIG. 10, the vehicle attachment device 114 and the waste receptacle attachment device 116 are connected by at least one flexible linkage member 156. Flexible linkage member 156 provides for variable height adjustments based on the size and shape of the waster receptacle 100 as well as the vehicle 132. Flexible linkage member 156 can comprise any suitable flexible material, for example hollow or solid metallic members, suitable polymers, and polymeric or rubber encapsulated metallic rods.

In operation, waste receptacle 100 is generally positioned at the rear of vehicle 132. When waste receptacle 100 is positioned on its bottom 106, the preferred orientation for engaging the waste receptacle transport device 112 to the body surface 136 of vehicle 132 can be determined such that the waste receptacle 100 is lifted off of bottom 106 and onto wheels 108. The preferred body surface 136 will be such that the waste receptacle transport device 112 does not bear the weight of waste receptacle 100 and its contents, but instead wheels 108 of waste receptacle 100 bear the weight such that the waste receptacle transport device 112 merely tows the waste receptacle 100 as opposed to carrying the waste receptacle 100.

After determining the body surface 136 for engaging the waste receptacle transport device 112 to vehicle 132, the preferred angular orientation of suction cup 144 and offset linkage bar 118 can be determined. Interface surface 134 of suction cup 144 is positioned on the body surface 136 of the vehicle 132 and moveable handle 148 is moved from the unengaged position to the engaged position. Lock 150 is moved from the unlocked position to the locked position to retain moveable handle 148. Waste receptacle 100 is then tilted off of its bottom 106 and onto its wheels 108 and elastomeric straps 126 are secured around handle portion 110 of waste receptacle 100. The ends of elastomeric straps 126 are secured to arms 120a, 120b by way of apertures 41.

Once the waste receptacle 100 is attached to the waste receptacle transport device 112, the waste receptacle 100 is then towed behind vehicle 132 to the desired location. For safety reasons, vehicle 132 is preferably driven so as to not exceed 10 miles per hour. Once at the desired location, the moveable handle 148 is moved from the engaged position to the unengaged position such that suction cup 144 disengages from the body surface 136 of the vehicle 132 such that the waste receptacle transport device 112 is no longer connected to vehicle 132. At this point, the waste receptacle 100 can be unsecured from the handle attachment device 122 by removing the elastomeric straps 126 or alternatively, the waste receptacle transport device 112 may be left attached to the waste receptacle 100. If the elastomeric straps 126 are removed from the handle 20, the waste receptacle transport device 112 can be stored.

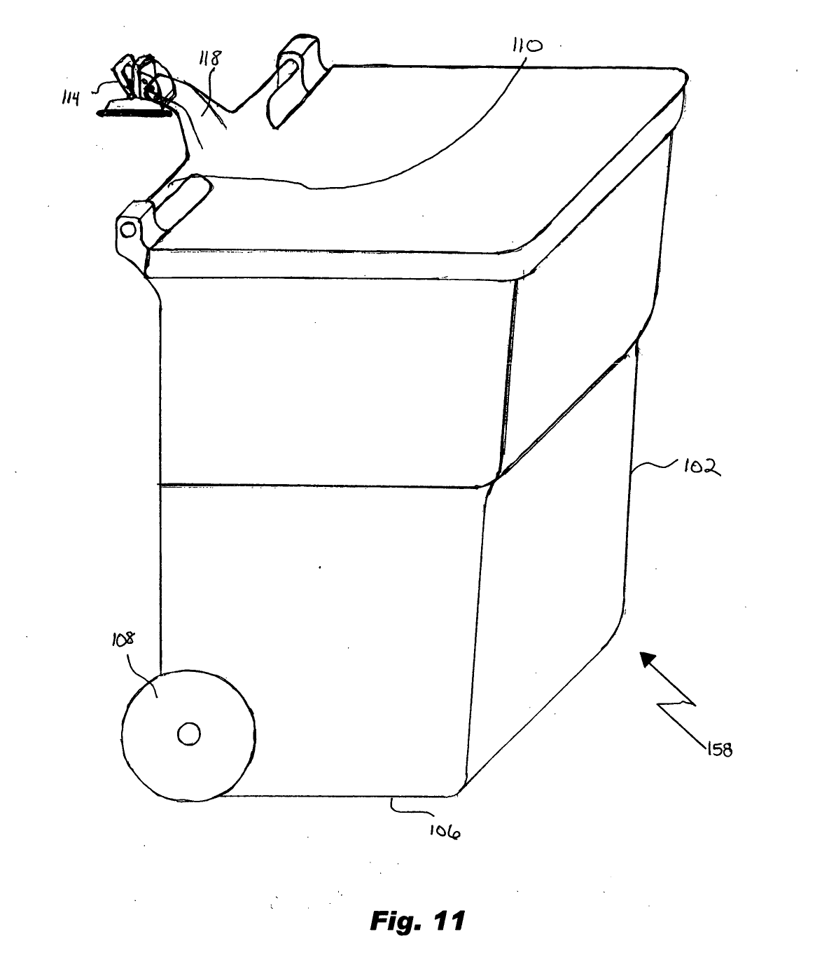

It is important to notice that there are numerous different ways of utilizing the waste receptacle transport device 112. For example, the offset linkage bar 118 can be formed integrally with the handle portion 110 of the hinged lid 104 to form a tow-ready waste receptacle 158 as shown in FIG. 11. The tow-ready waste receptacle 158 would only require attachment of the vehicle attachment device 114 to the vehicle 132 prior to use. In a similar embodiment, waste receptacle transport device 112 could be manufactured such that the arms 120a, 120b on waste receptacle attachment device 116 include a throughbore for permanently attaching the waste receptacle transport device 112 to the handle portion 110 of the waste receptacle 100 to form another version of a tow-ready waste receptacle.

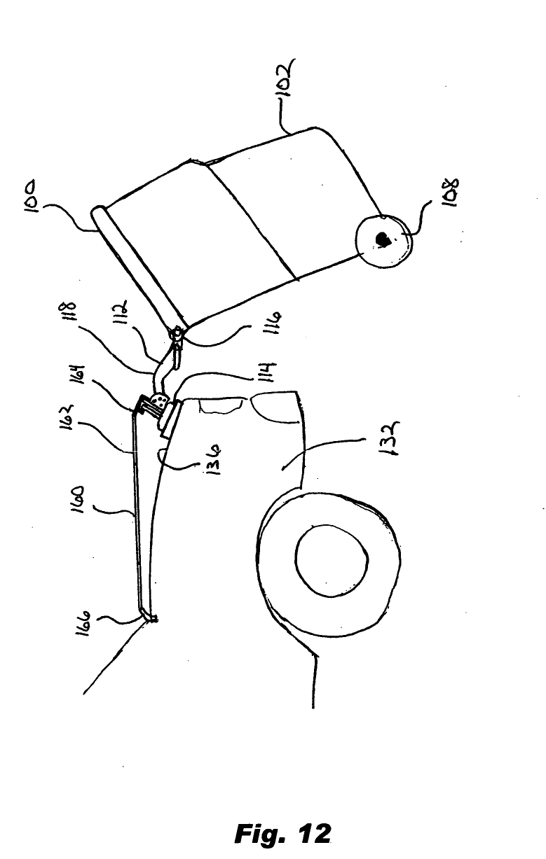

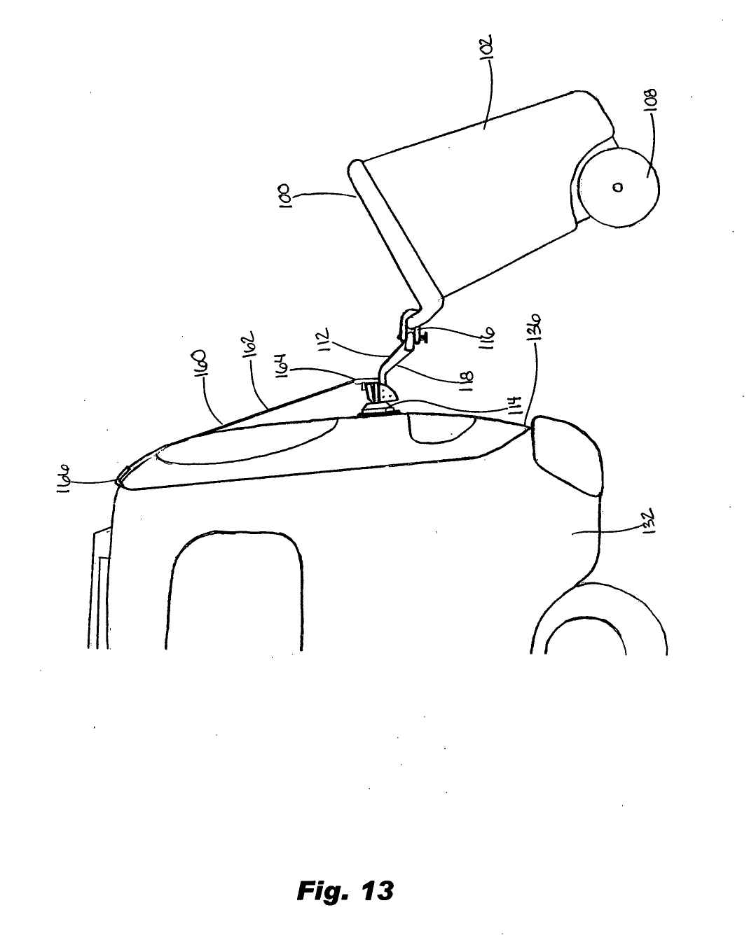

In some instances, the waste receptacle transport device 112 can be used in conjunction with a securement strap 160 as depicted in FIGS. 12 and 13. Securement strap 160 comprises a length adjustable strap 162 with a first clip 164 and a second clip 166. First clip 164 can engage the vehicle attachment device 114 for example the moveable handle 148, fixed handle 146 or lock 150 while the second clip 166 engages a suitable location on the vehicle 132. Securement strap 160 assists in maintaining the position of suction cup 144 in abnormal towing conditions such as heavy loading of waste receptacle 100 or when the body surface 136 is moist or slick.

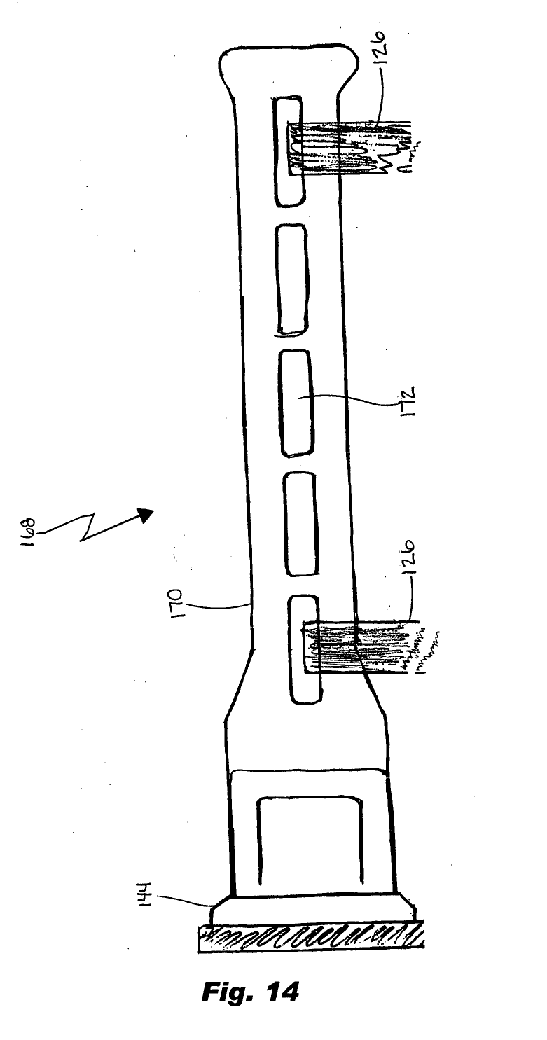

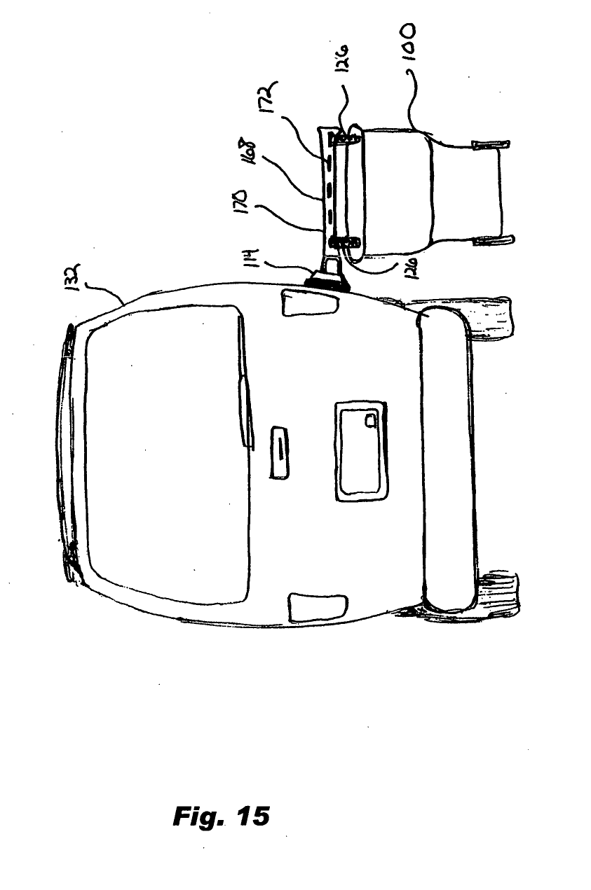

In another alternative embodiment depicted in FIGS. 14 and 15, a side-mount waste receptacle transport device 168 can be constructed and used when the vehicle 132 does not have a suitable rear surface. Side-mount waste receptacle transport device 168 comprises a rigid linkage bar 170. Rigid linkage bar 170 includes suction cup 144 on one end, a plurality of apertures 172 and flexible, elastomeric straps 126. Rigid linkage bar 170 must have enough strength and rigidity to continually position the waste receptacle 100 away from vehicle 132 during towing.

Although a variety of embodiments of a waste receptacle transport device have been shown and described with respect to specific details of certain embodiments thereof, it is not intended that such details limit the scope of the invention, taking into consideration reasonable equivalents thereof.

1. A waste receptacle transport device, comprising:
a vehicle attachment device that is configured for removable adhesion to a body surface of an automobile; and
a waste receptacle attachment device attached to said vehicle attachment device, wherein said waste receptacle attachment device includes a handle attachment device that is removably securable about a handle of a wheeled waste receptacle.

2. The device of claim 1, wherein the removable adhesion is provided by a suction cup or magnet.

3. The device of claim 1, wherein the vehicle attachment device comprises a multi-positionable bracket to provide angular adjustability of said vehicle attachment device.

4. The device of claim 1, wherein said handle attachment device comprises a flexible, elastomeric strap, a hook and loop fastener, a bungee cord or metal chain.

5. The device of claim 1, wherein said waste receptacle attachment device comprises a bar that is coupled to said vehicle attachment device.

6. The device of claim 5, wherein said bar is presented in a straight or y-shaped configuration.

7. The device of claim 5, wherein said bar includes at least one aperture adapted to receive the handle attachment device.

8. The device of claim 1, wherein said vehicle attachment device and said waste receptacle attachment device are operatively connected at opposing ends of at least one linkage member.

9. The device of claim 8, wherein said at least one linkage member comprises an offset linkage member.

10. The device of claim 8, wherein said at least one linkage member comprises a flexible linkage member.

11. The device of claim 1, wherein said vehicle attachment device comprises a securement strap adapted to simultaneously attach to the vehicle attachment device and a vehicle body.

12. A method for towing a residential waste container from a loading location to a collection location comprising:
coupling a vehicle attachment device on a towing apparatus to a body surface on a tow vehicle;
securing a container attachment device on the towing apparatus to a handle on the residential waste container;
driving the tow vehicle from the loading location to the collection location such that the residential waste container rolls on a pair of container wheels behind the tow vehicle.

13. The method of claim 12, further comprising:
removing the vehicle attachment device from the body panel on the tow vehicle once the residential waste container is positioned at the collection location.

14. The method of claim 13, further comprising:
releasing the container attachment device from the handle of the residential waste container to facilitate storage of the towing apparatus.

15. The method of claim 12, wherein coupling a vehicle attachment device on a towing apparatus to a body surface on a tow vehicle comprises attaching the vehicle attachment device to a rear body surface or a side body surface of the tow vehicle.

16. A towable waste container comprising:
a waste receptacle having a pair of wheels and a hinged lid; and
a vehicle attachment device that is configured for removable adhesion to a body surface of an automobile;
wherein said vehicle attachment device is operably attached to said hinged lid with at least one linkage member such that attaching said vehicle attachment device to a body surface of a vehicle allows for towing of said waste receptacle.

17. The towable waste container of claim 16, wherein said at least one linkage member is selectively removable from said hinged lid.
